(19) United States
(12) Patent Application Publication
(10) Pub. No.: US 2022/0225796 A1
(43) Pub. Date: Jul. 21, 2022

(54) WALL HOOK, FIXING ARRANGEMENT HAVING THE WALL HOOK, AND METHOD FOR FIXING THE WALL HOOK

(71) Applicant: fischerwerke GmbH & Co. KG, Waldachtal (DE)

(72) Inventor: Aaron DALY, Pfalzgrafenweiler (DE)

(21) Appl. No.: 17/607,051

(22) PCT Filed: Apr. 8, 2020
(86) PCT No.: PCT/EP2020/059955

§ 371 Date: Oct. 28, 2021

(30) Foreign Application Priority Data
May 2, 2019 (DE) 10 2019 111 283.4
Apr. 3, 2020 (DE) 10 2020 109 317.9

(51) Int. Cl. A47G 1/16

(52) U.S. Cl. CPC A47G 1/164

(57) ABSTRACT

A wall hook for fixing in an anchoring substrate. In order that a hook part of the wall hook can be aligned at any desired spacing from the anchoring substrate, the wall hook includes a stop element which extends away from a hook element parallel to a longitudinal axis, the hook part being rotatable relative to the stop element about the longitudinal axis.

### TECHNICAL FIELD

The invention relates to a wall hook, to a fixing arrangement and to a method for fixing the wall hook.

### DISCUSSION OF THE RELATED ART

One-piece wall hooks made of metal are known which have a straight shank extending along a longitudinal axis. The shank is usually in the form of a nail or screw. Such wall hooks have a hook part formed integrally with a rear end, which hook part projects at a right-angle radially from the longitudinal axis of the shank. If such a wall hook having a screw thread is screwed into an anchoring substrate, and if the hook part is to be aligned in a specified direction, for example vertically upwards on a wall, this is possible only with simultaneous alteration of the spacing of the hook part from the anchoring substrate, because the wall hook, while being aligned, is simultaneously screwed into and out of the anchoring substrate. Any desired alignment of the hook part at a specific spacing from the anchoring substrate is accordingly not possible.

Utility model DE 295 19 158 U1, however, shows a multi-part wall hook which can be aligned as desired at a specified distance from the anchoring substrate. The wall hook consists of a screw as fixing element on which a separate hook element has been rotatably mounted. The hook element is one-piece and has a shank receiver for receiving the screw. At the rear end of the hook element, a hook part projects outwards from the shank receiver radially of the longitudinal axis to one side of the shank receiver of the hook element. At a front end of the hook element, a flange having short, radially extending ribs is arranged on the shank receiver. If, after alignment of the hook part, the flange is clamped against an anchoring substrate with the screw, the ribs are pressed against the surface of the anchoring substrate and hold the hook part by friction against the anchoring substrate so as to be fixed against rotation. However, it is not possible to adjust the spacing between the hook part and the anchoring substrate.

### SUMMARY OF THE INVENTION

The problem of the invention is therefore to propose a wall hook wherein the spacing and the alignment of the hook part are adjustable as desired and independently of one another.

That problem is solved according to the invention by a wall hook, a fixing arrangement and a method as described herein. The wall hook according to the invention for fixing in an anchoring substrate comprises a fixing element and a hook element. The fixing element has a shank extending in the direction of a longitudinal axis of the wall hook, which shank is elongated in the direction of the longitudinal axis, that is to say the length of the fixing element is greater in the direction of the longitudinal axis than its dimension radially with respect to the longitudinal axis. The fixing element can be a screw or a nail. Preferably the fixing element is a screw having a shank on which there is arranged a thread which extends in a longitudinal direction, that is to say winds around the longitudinal axis. The shank especially merges into a screw head which has a larger diameter than the shank with the thread. The hook element has a shank receiver for receiving the fixing element, with which the hook element is mountable on the shank of the fixing element so that a hook part of the hook element projects outwards to one side of the hook element radially with respect to the longitudinal axis. “Mountable” means herein especially that the hook element can be mounted on the fixing element, especially on the shank thereof, along the longitudinal axis or by movement radially with respect to the longitudinal axis. “Mountable” can, however, also mean, for example, that the hook element is screwed in the region of a thread of the fixing element and pushed in a thread-free region. The shank receiver is especially configured in such a way that it encompasses more than half of the shank of the fixing element in the circumferential direction. In particular, the shank receiver is implemented as a kind of sleeve which is especially annular and fully closed. The hook part is part of the hook element and projects laterally from the shank of the fixing element, radially with respect to the longitudinal axis, when the hook element has been mounted on the shank of the fixing element by means of the shank receiver, i.e. once the shank has been introduced into the shank receiver. The hook part is rotatable relative to the fixing element in the circumferential direction about the longitudinal axis so that it can be aligned by rotation about the longitudinal axis, and accordingly about the shank. The hook part is especially arranged in a region of the hook element that is at the rear in the direction of introduction of the hook element into the anchoring substrate, especially at the rear end of the hook element.

According to the invention, the wall hook comprises a stop element which serves as stop or counterbearing for the hook part. The stop element extends away from the hook element parallel to the longitudinal axis and has a radial extent with respect to the longitudinal axis that is smaller than that of the hook part in relation to the direction in which the hook part projects radially with respect to the longitudinal axis. That means that on the side to which the hook part projects outwards radially with respect to the longitudinal axis, the hook part projects outwards beyond the stop element in the radial direction.

In order to ensure that the hook part can be aligned independently of the stop element, in accordance with the invention the hook part is rotatable relative to the stop element about the longitudinal axis even before the wall hook is fixed in the anchoring substrate. Alternatively, the stop element is connected to the hook element by means of a predetermined breaking point which is severed by rotation about the longitudinal axis during fixing of the wall hook in the anchoring substrate or which at least allows the hook element to be twisted once the spacer element has been introduced into the anchoring substrate during fixing of the wall hook. “Alignment” means rotation of the hook part about the longitudinal axis.

During the fixing of the wall hook, the front end of the stop element, which end faces away from the wall hook in the direction of the longitudinal axis, penetrates directly or indirectly into the anchoring substrate so that the stop element is initially partly introduced, and especially so as to be secure against rotation, into the anchoring substrate and the rear end of the stop element, which end faces towards the wall hook in the direction of the longitudinal axis, can be set at a spacing from the anchoring substrate desired by the user. “Direct penetration” means here that the spacer element comes directly into contact with the anchoring substrate, while “indirect penetration” means the case where the spacer element penetrates into an element arranged in the anchoring substrate, for example into an expansion sleeve of an expansible fixing plug introduced into a drilled hole. If, for example, a screw as fixing element is screwed into a wooden beam, the stop element is able to penetrate directly into the wood, so that it enters directly into engagement with the wood. If, however, the anchoring substrate is a concrete wall, there is used for the fixing of the wall hook especially an expansible fixing plug having an expansion sleeve made of plastics material, into which the screw of the wall hook is screwed. In that case the stop element penetrates into the expansible fixing plug as the screw is screwed in, so that the expansion sleeve is arranged between the concrete and the stop element. In that case the stop element enters indirectly into engagement with the anchoring substrate.

Once the spacer element has been at least partly introduced into the anchoring substrate, by virtue of the configuration of the wall hook according to the invention the hook part can be aligned by rotation about the longitudinal axis, the stop element especially being held fixed against rotation relative to the anchoring substrate so that on rotation of the hook part it does not rotate therewith. The rear end of the stop element forms the stop against which the hook element rests after fixing and against which it is clamped. The spacer element is installed in the anchoring substrate “fixed against rotation” relative to the anchoring substrate if the torque that needs to be applied to the stop element in order to rotate the stop element about the longitudinal axis is greater than that necessary to rotate the hook part about the longitudinal axis and relative to the stop element.

During fixing, the stop element is introduced into the anchoring substrate until a rear end of the stop element is located at a desired intended spacing from the anchoring substrate. In that position, the stop element, which is especially fixed against rotation relative to the anchoring substrate, forms a stop for the hook element, which can be rotated relative to the stop element about the longitudinal axis and aligned. The hook element can be clamped against the stop element with the fixing element in such a way that a frictional force acts between the hook element and the stop element, which frictional force prevents unintentional twisting of the hook part about the longitudinal axis.

This means that the hook part can be clamped against the stop element at any desired spacing from the anchoring substrate, the stop element acting as counterbearing and spacer for the hook part, but being capable of alignment relative to the stop element in the event that the hook part, while being clamped against the stop element, is twisted into an unintended, undesirable position, for example by rotation of a screw used as fixing element. In that case a frictional force acts between the stop element and the hook element, which frictional force is sufficiently small to enable the hook part to be rotated and aligned relative to the stop element but is sufficiently large to prevent the hook part from twisting into an unintended, undesirable position as a result of its inherent weight or as a result of jolting.

Accordingly, for fixing the wall hook in an anchoring substrate, in accordance with the invention the fixing element is introduced into the anchoring substrate, the stop element entering into direct or indirect engagement with the anchoring substrate. In particular, the stop element is then fixed against rotation relative to the anchoring substrate. After the introduction of the stop element, the hook element is rotated about the longitudinal axis and aligned relative to the stop element. During or after those steps, the hook element is clamped against the stop element in the axial direction in such a way that a frictional force acts between the hook element and the stop element, which frictional force prevents unintentional twisting of the hook part about the longitudinal axis.

For example, for mounting a picture on a vertical wall, after part of the fixing element and of the stop element have been introduced into the wall acting as anchoring substrate, the hook part can be aligned so as to project vertically upwards once the shank of the fixing element has been horizontally aligned. By axial clamping of the hook element against the spacer element, a frictional force acts between the clamped elements which prevents unintentional twisting of the hook part about the longitudinal axis, for example when an eyelet of a picture is being mounted. Then, for example, an eyelet of a picture that is to be hung can be mounted on the hook part so that the eyelet cannot be removed axially from the shank and/or from the shank receiver in the direction of the hook part, but has to be moved away from the shank and/or from the shank receiver, in the direction in which the hook part projects from the shank, to an extent sufficient for the eyelet to be taken off the shank and/or the shank receiver over the hook part and in that way demounted from the wall hook or from the hook element.

According to the invention, the stop element of the wall hook according to the invention can be connected to the hook element by means of a predetermined breaking point. The predetermined breaking point enables the hook element to be produced with the stop element as a single part, that is to say together and in one piece, especially from plastics material in an injection-moulding process. The predetermined breaking point holds the stop element and the hook element captively together, which is advantageous for production, packaging and transport of the wall hook. The connection can then be broken during the actual fixing of the wall hook. According to the invention, during or after the introduction of the fixing element and the stop element into the anchoring substrate, the predetermined breaking point, which is arranged between the stop element and the hook element, is severed so that, after severing, the hook part is rotatable relative to the stop element about the longitudinal axis. The expression “severing” therefore includes in this context also the case where the stop element is not fully detached from the hook element but the predetermined breaking point is only weakened to the extent that the hook part is rotatable relative to the stop element about the longitudinal axis, the material of the predetermined breaking point being, for example, plastically deformed. In particular, the fixing element is a screw and the severing takes place as the screw is screwed into the anchoring substrate. In particular, during screwing-in the hook element rotates together with the screw, especially as a result of friction between the hook element and a head of the screw, the underside of which head is in surface contact with the hook element, whereas the stop element enters into engagement with the anchoring substrate and is thereby held against the anchoring substrate so as to be fixed against rotation. During screwing-in of the screw, the hook element is then rotated relative to the stop element about the longitudinal axis, the predetermined breaking point being severed. For example, the predetermined breaking point consists of a thin injection-moulded skin or of individual thin webs.

The wall hook according to the invention together with the expansible fixing plug forms a fixing system and together with the expansible fixing plug or solely together with the anchoring substrate forms a fixing arrangement.

In order to facilitate penetration of the stop element into the anchoring substrate and engagement of the stop element with the anchoring substrate, the stop element tapers wedge-like or sleeve-like at its front end that faces away from the hook part. In particular, the stop element forms a kind of spike which has a tip for penetration into the anchoring substrate or into an expansion sleeve which engages at least partly around the shank of the fixing element. In particular, the stop element is a hollow cylinder having a hollow-cone-shaped tip which receives the shank of the fixing element in its cavity.

Furthermore, it is preferred that the length of the stop element in the direction of the longitudinal axis is greater than its extent radially with respect to the longitudinal axis. That is to say, the radius of a circle circumscribing the stop element is smaller than the axial length of the stop element in the direction of the longitudinal axis. The circle especially circumscribes the stop element in a region of the stop element that faces away from the hook part, especially in a front third that faces towards the anchoring substrate during mounting. In particular, the stop element extends along the longitudinal axis over a length that is greater, especially a multiple greater, than a diameter of the shank of the fixing element to be received in the shank receiver. “Multiple” means here especially at least 1.5 times, especially at least 2.0 times. In particular, the entire stop element extends in the direction of the longitudinal axis with a length corresponding to from 1.0 times to 2.5 times, especially from 1.5 times to 2.0 times, the external diameter of a head of the fixing element. A long stop element allows adjustment of the spacing of the hook part from the anchoring substrate over a large spacing range.

Preferably, for preventing rotation the stop element has grooves and/or ribs which run in the direction of the longitudinal axis. The grooves and/or ribs are arranged on the surface and act as anti-rotation devices which engage directly or indirectly interlockingly in the anchoring substrate. The grooves and/or ribs secure the stop element in the anchoring substrate against rotation about the longitudinal axis during alignment of the hook part, because, as a result of the form of those elements, the outer side of the stop element does not have a circular cross-section and/or does not have a smooth surface. The “surface” is the area of the stop element which enters directly into contact with the anchoring substrate in the case of direct introduction.

In an embodiment of the wall hook according to the invention, the stop element is connected to the hook element, especially so as to be axially fixed, by means of an interlocking and/or frictional connection. The connection can especially be implemented as a kind of push-fit connection. For example, hollow-cylindrical pipe sections engage frictionally one inside the other, so that the individual parts are, by friction alone, captively connected, especially so as to be axially fixed, but are rotatable relative to one another about the longitudinal axis. An interlocking connection can be realised, for example, by an undercut tongue into which a complementary counter-tongue engages, as known from annular snap connections. In the case of a frictional and/or interlocking connection, the two elements to be connected can be united by overmoulding in an injection-moulding process after production of the elements or during production of at least one of the elements.

The stop element and the hook element are preferably produced from the same material, especially from plastics material in an injection-moulding process, with the result that economical production is possible. For example, the stop element and the hook element consist of a glass-fibre-reinforced polyamide. In that case the hook element and the stop element are especially produced together in one piece with a predetermined breaking point in an injection-moulding process.

Alternatively the stop element and the hook element can consist of different materials. For example, the hook element consists, for example, of metal and the stop element of plastics material. The use of different plastics materials for the stop element and the hook element and the production of the two elements in successive steps in a multi-component injection-moulding process are also possible. For example, the stop element is injection-moulded from polyoxymethylene (POM) and then overmoulded with a polyamide, from which the hook element is produced, to form an interlocking connection.

In a preferred embodiment of the wall hook according to the invention, the stop element consists of a plurality of parts; the stop element especially has a penetration element and a spacer element. In particular, the plurality of parts are connectible to one another, for example by means of a push-fit connection, so that the length of the stop element can be matched to the desired spacing between the hook part and the anchoring substrate.

The features and combinations of features, configurations and embodiments of the invention mentioned above in the description, as well as the features and combinations of features mentioned below in the description of the Figures and/or shown in a Figure, can be employed not only in the particular combination defined or shown in each case, but also in basically any other combinations or on their own. Configurations of the invention that do not have all features of a dependent claim are possible. It is also possible for individual features of a claim to be replaced by other disclosed features or combinations of features. Configurations of the invention that do not have all the features of the exemplary embodiment(s), but have in principle any part of the characterised features of an exemplary embodiment optionally in combination with one, some or all features of one or more further exemplary embodiments, are possible.

### BRIEF DESCRIPTION OF THE DRAWINGS

The invention is explained in greater detail below with reference to three exemplary embodiments shown in the drawing, wherein

FIG. 1 shows a first wall hook according to the invention in a side view;

FIG. 2 shows the first wall hook according to the invention in a sectional view;

FIG. 3 shows the hook element of the first wall hook according to the invention in a perspective sectional view;

FIGS. 4 to 9 show the fixing of the first wall hook according to the invention in an anchoring substrate;

FIG. 10 shows a second wall hook according to the invention in a perspective sectional view; and

FIG. 11 shows the hook element of the first wall hook according to the invention in a sectional view.

### DETAILED DESCRIPTION OF THE INVENTION

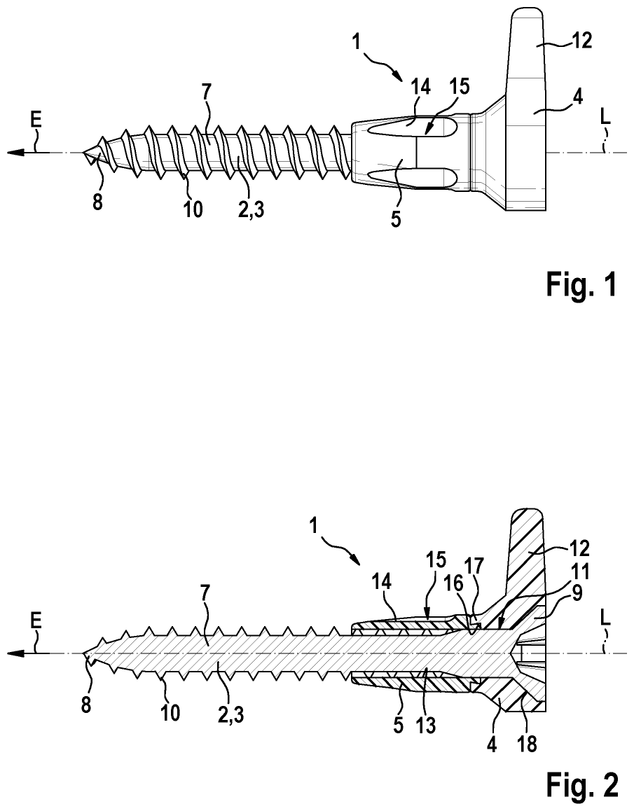

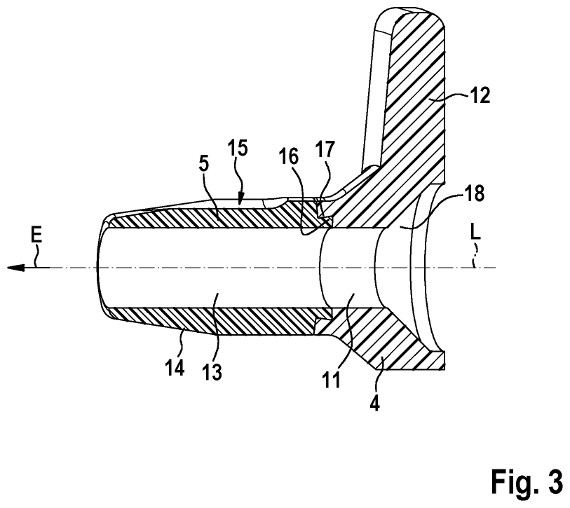

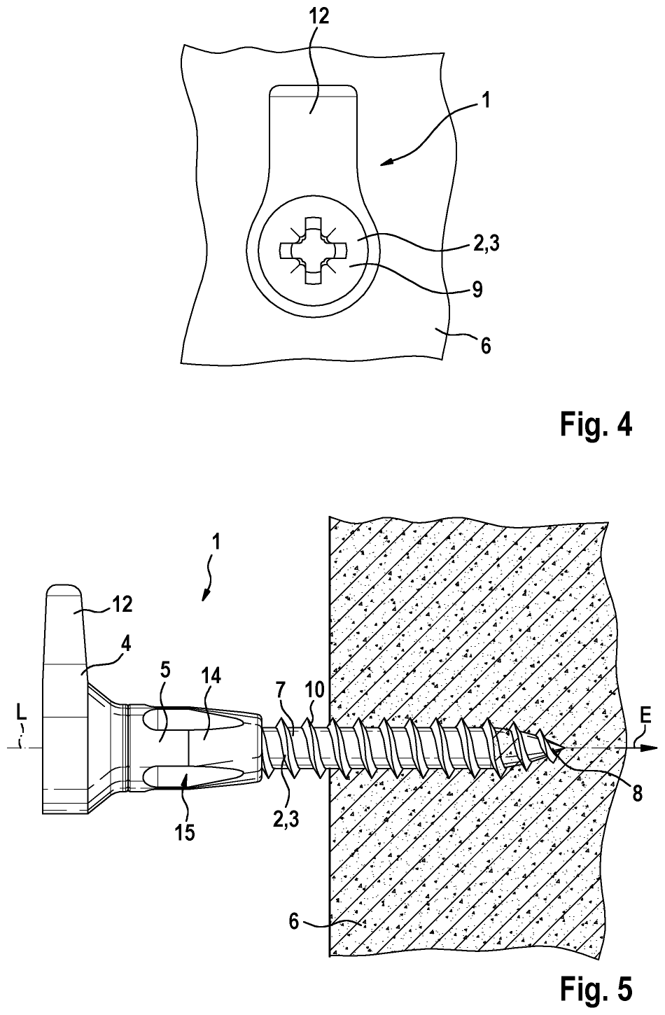

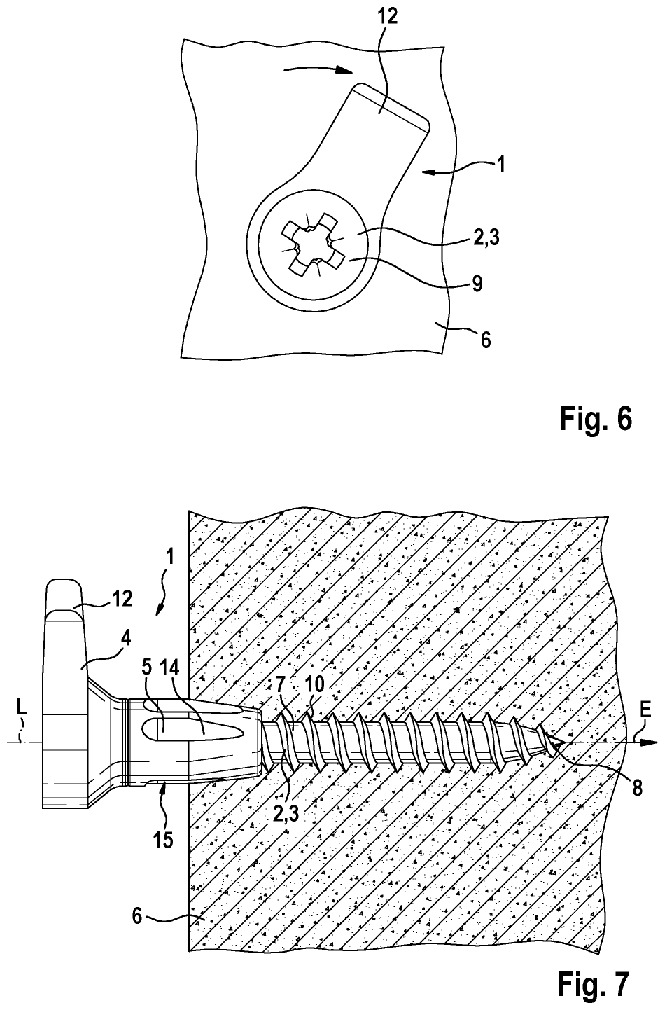

FIGS. 1 to 9 show a first wall hook 1 according to the invention. The wall hook 1 consists of a screw 2 made of steel as fixing element 3, a hook element 4 and a stop element 5, which is arranged in front of the hook element 4 in the introduction direction E. The introduction direction E is the direction in which the screw 2 is screwed into an anchoring substrate 6 (see FIGS. 4 to 9). A shank 7 of the screw 2 extends along a longitudinal axis L of the wall hook 2 and has a screw tip 8 at its front end in the introduction direction E and at its rear end a screw head 9 having a tool receiver for a rotary tool (not shown). A thread 10 extends from the screw tip 8 over a large portion of the shank 7 towards the screw head 9. The shank 7 of the screw 2 is installed in a sleeve-like shank receiver 11 of the hook element 4, which shank receiver entirely encompasses the shank 7 in the circumferential direction. The shank receiver 11 passes fully through the hook element 4 in the direction of the longitudinal axis L and has in a rear region a conical widened portion 18 for receiving the screw head 9. Formed in one piece with the shank receiver 11 there is arranged a parallelepipedal cantilever arm as hook part 12 which projects outwards from the shank receiver 11 to one side radially with respect to the longitudinal axis L. In front of the hook element 4 in the introduction direction E there is arranged the stop element 5 which extends away from the hook element 4 parallel to the longitudinal axis L. The extent of the stop element 5 in the direction of the longitudinal axis L is approximately three times as great as its extent radially with respect to the longitudinal axis L which corresponds to the radius of a circle circumscribing the stop element 5, which circle lies in a radial plane with respect to the longitudinal axis and the centre point of which lies on the longitudinal axis. In contrast, the radial extent of the hook part 12 is more than three times as great as that of the stop element 5, so that, for example, an eyelet of a picture (not shown) can be supported on the stop element 5 and, by means of the hook part 12, is secured against slipping off the wall hook 1 in a direction opposite to the introduction direction E.

The stop element 5 is a hollow-cylindrical sleeve which has a cylindrical opening 13 for the shank 7 of the screw 2. The stop element 5 tapers conically at its front end in the introduction direction E that faces away from the hook part 12 or tapers wedge-like in the region of the ribs 14. The ribs 14 are arranged on the surface of the stop element 5 and run in the direction of the longitudinal axis L, as do grooves 15 arranged between the ribs 14 in the circumferential direction. At its rear end in the introduction direction E, the stop element 5 has a trapezoidal circumferential tongue 16, the radial extent of which with respect to the longitudinal axis L increases in a direction opposite to the introduction direction E and engages behind a complementary counter-tongue 17 of the hook element 4, so that the stop element 5 and the hook element 4 are interlockingly connected to one another so as to be axially fixed. The stop element 5 and the hook element 4 are, however, rotatably connected by the interlocking connection, that is to say the hook part 12 is rotatable relative to the stop element 5 about the longitudinal axis L. The hook element 4 and the stop element 5 consist of different materials. The hook element 4 is made in one piece from a glass-fibre-reinforced polyamide, while the stop element 5 consists of a polyoxymethylene (POM). The stop element 5 is produced together with the hook element 4 in a two-component injection-moulding process, wherein first the stop element 5 is injection-moulded and then the stop element 5 is overmoulded in the region of its tongue 16 with the material of the hook element 4, the counter-tongue 17 being formed around the tongue 16.

For fixing the wall hook 1 in an anchoring substrate 6, which is a wooden beam in the exemplary embodiment, the screw 2 is first screwed into the anchoring substrate 6, as shown in FIGS. 4 and 5. The anchoring substrate 6 is part of a wall and in this case the hook part 12 is first aligned perpendicularly upwards, as shown in FIG. 4. In that position the hook part 12 is initially held in the desired alignment by a user while the screw 2 is being screwed into the anchoring substrate 6. During further screwing-in, the stop element 5 is introduced with the screw 2 into the anchoring substrate 6 so that it enters into engagement with the anchoring substrate 6. As a result of the spike-like or nail-like taper of the front end of the stop element 5, the stop element 5 is easily able to penetrate into the wooden beam as anchoring substrate 6, during which the grooves 15 together with the ribs 14 act as anti-rotation elements which prevent the stop element 5 from twisting about the longitudinal axis L (FIGS. 6 and 7). The stop element 5 is then fixed against rotation relative to the anchoring substrate 6. The screw 2 is screwed into the anchoring substrate 6 until the desired spacing between the hook part 12 and the anchoring substrate 6 has been achieved (FIG. 7). As a result of the further penetration of the stop element 5 into the anchoring substrate 6, the resistance to penetration into the anchoring substrate 6 is increased on account of the increasingly large cross-section of the stop element 5, so that the screw head 9 is pressed more strongly against the conical widened portion 18. As a result, as the screw 2 is screwed in, it is possible for the hook element 4 to be unintentionally twisted about the longitudinal axis L (FIG. 6) and be no longer aligned upwards as desired. Since the hook element 4 and the stop element 5 are rotatable relative to one another, the hook element 4 can then be rotated about the longitudinal axis L relative to the stop element 5, which is connected to the anchoring substrate 6 so as to be fixed against rotation, and aligned in the desired position, as shown in FIGS. 8 and 9. The hook part 12 of the wall hook 1 then has the desired alignment and the desired spacing. Spacing and alignment are adjustable independently of one another. The stop element 5 acts as stop and counter-bearing for the hook element 4, which is pressed against the stop element 5 with the screw 2, so that a frictional force acts between the hook element 4 and the stop element 5, which frictional force, once the hook part 12 has been aligned, prevents the alignment of the hook part 12 from being altered by jolting or contact, as may act on the hook part 12, for example, during mounting of an eyelet of a picture to be hung.

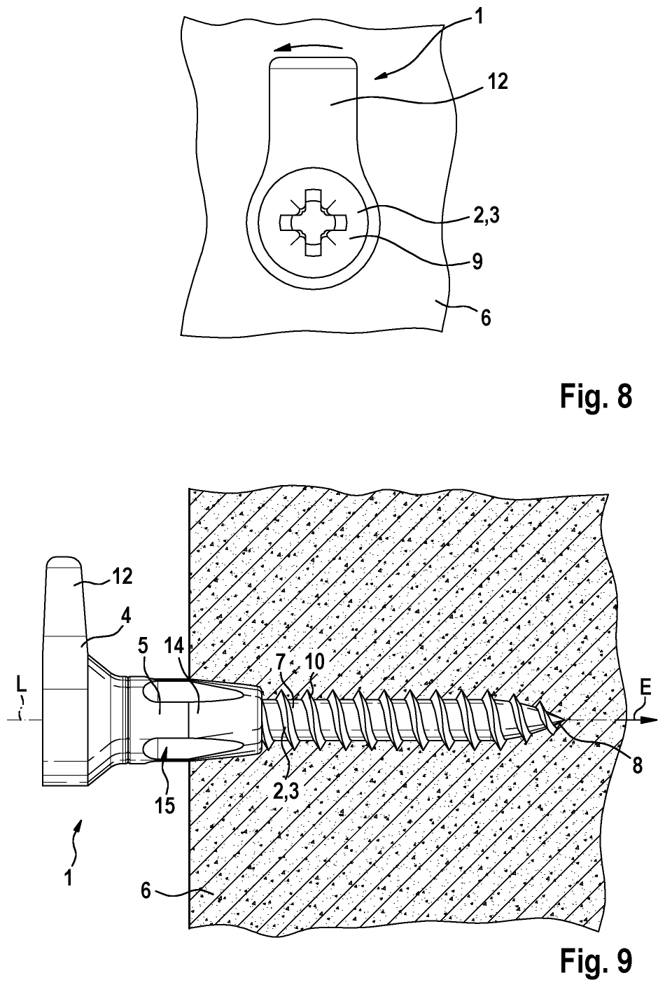

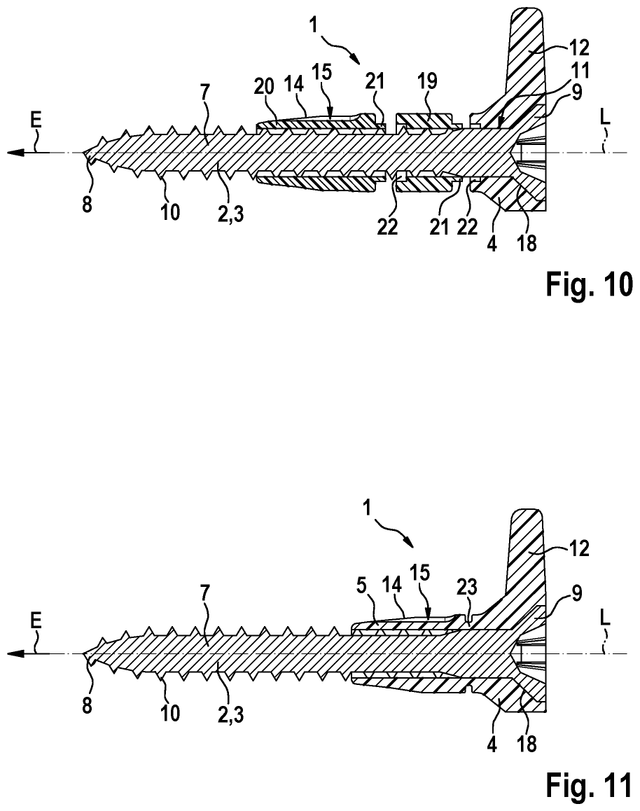

The further exemplary embodiments shown in FIGS. 10 and 11 have many aspects in common with the first exemplary embodiment. Components having the same function are therefore denoted by the same reference symbols and the following description is limited to the differences with respect to the first exemplary embodiment.

The wall hook 1 according to the invention shown as second exemplary embodiment in FIG. 10 differs from the wall hook 1 of the first exemplary embodiment of FIGS. 1 to 9 in essentially two features: firstly, the stop element 5 consists of a plurality of parts. A spacer element 19 belonging to the stop element 5 is arranged in front of the hook element 4 in the introduction direction E and behind a front part 20 of the stop element 5, which front part has the taper and the ribs 14 and grooves 15 for preventing rotation. As a result of the introduction of the spacer element 19 between the front part 20 and the hook element 4, the hook part 12 can be arranged at a greater distance from the anchoring substrate 6. Secondly, the front portion 20, the spacer element 19 and the hook element 4 are connected by frictional engagement but not by interlocking. In this exemplary embodiment, complementary hollow-cylindrical portions 21 engage frictionally in complementary hollow-cylindrical recesses 22 in such a way that they connect the three parts 4, 19, 20 to one another by frictional engagement so as to be axially fixed and rotatable.

In contrast, the hook element 4 is made in one piece with the stop element 5 of the wall hook 1 of the third exemplary embodiment shown in FIG. 11 from a plastics material, so that the stop element 5 and the hook element 4 consist of the same material, that is to say of glass-fibre-reinforced polyamide. The hook element 4 and the stop element 5 are connected to one another by means of a predetermined breaking point 23 which is in the form of a portion of greatly reduced wall thickness between the hook element 4 and the stop element 5. The injection-moulded skin forming the predetermined breaking point 23 connects the two elements 4, 5 so as to be axially fixed and captive. If during fixing, however, the hook element 4 is twisted relative to the stop element 5, which is connected to the anchoring substrate 6 so as to be fixed against rotation, the predetermined breaking point 23 will be severed so that the hook element 4 can be rotated relative to the stop element 5 about the longitudinal axis L for the purpose of alignment. The severing can occur as early as during the screwing-in of the screw 2 into the anchoring substrate 6, especially as a result of the contact of the screw head 9 with the conical widened portion 18, so that the hook element 4 rotates together with the screw 2 on account of the friction effective between the screw head 9 and the conical widened portion 18.

### LIST OF REFERENCE SYMBOLS

1 wall hook
2 screw
3 fixing element
4 hook element
5 stop element
6 anchoring substrate
7 shank
8 screw tip
9 screw head
10 thread
11 shank receiver
12 hook part
13 opening
14 rib
15 groove
16 tongue
17 counter-tongue
18 conical widened portion
19 spacer element
20 front part of the stop element 5
21 hollow-cylindrical portion
22 hollow-cylindrical recess
23 predetermined breaking point
E introduction direction
L longitudinal axis

1. A wall hook for fixing in an anchoring substrate,
having a fixing element and a hook element,
wherein the fixing element has a shank which is elongated in the direction of a longitudinal axis of the wall hook, and
wherein the hook element has a shank receiver for receiving the fixing element, and a hook part which projects outwards from the shank receiver to one side radially with respect to the longitudinal axis,
wherein
the wall hook comprises a stop element which extends away from the hook element parallel to the longitudinal axis and has an extent radially with respect to the longitudinal axis that is smaller than that of the hook part; and
the hook part is rotatable relative to the stop element about the longitudinal axis; or the stop element is separably connected to the hook element by means of a predetermined breaking point in such a way that the predetermined breaking point is severable by rotation about the longitudinal axis.

2. The wall hook according to claim 1, wherein the stop element tapers wedge-like or sleeve-like at its end that faces away from the hook part.

3. The wall hook according to claim 1, wherein the length of the stop element in the direction of the longitudinal axis is greater than its extent radially with respect to the longitudinal axis.

4. The wall hook according to claim 1, wherein the stop element has grooves and/or ribs running in the direction of the longitudinal axis for preventing rotation.

5. The wall hook according to claim 1, wherein the stop element is connected to the hook element by means of a frictional and/or interlocking connection.

6. The wall hook according to claim 1, wherein the stop element and the hook element are made from the same material.

7. The wall hook according to claim 1, wherein the stop element and the hook element consist of different materials.

8. The wall hook according to claim 1, wherein the stop element consists of a plurality of parts.

9. A fixing arrangement having a wall hook according to claim 1 and an anchoring substrate in which the wall hook is fixed, wherein the stop element has been at least partly introduced into the anchoring substrate; and the hook part is rotatable relative to the stop element about the longitudinal axis.

10. A method for fixing the wall hook according to claim 1 in an anchoring substrate, having the following steps:
a) introduction of the fixing element into the anchoring substrate in such a way that the stop element enters into engagement with the anchoring substrate, and
b) rotation and alignment of the hook part relative to the stop element once the stop element has been at least partly introduced into the anchoring substrate.

11. The method according to claim 10, including step:
c) severing of a predetermined breaking point, which is arranged on the wall hook between the stop element and the hook element, during or after the introduction of the fixing element and the stop element into the anchoring substrate.

12. The method according to claim 11, wherein the fixing element is a screw; and the severing of the predetermined breaking point takes place as the screw is screwed into the anchoring substrate.

13. The wall hook according to claim 6, wherein the stop element and the hook element are made from the same plastics material.
